(19) United States
(12) Patent Application Publication
(10) Pub. No.: US 2022/0257472 A1
(43) Pub. Date: Aug. 18, 2022

(54) MEDICATION DISPENSER AND METHODS

(71) Applicant: Brian Alldridge, Portland, OR (US)

(72) Inventor: Brian Alldridge, Portland, OR (US)

(21) Appl. No.: 17/175,599

(22) Filed: Feb. 12, 2021

(51) Int. Cl. A61J 7/00; B29C 45/00

(52) U.S. Cl. CPC A61J 7/0076; B29L 2031/712; B29C 45/0053

(57) ABSTRACT

A medication dispenser is described that comprises a main body having a medication reservoir, a delivery tube, and one or more steering arms. The medication dispenser also has a cap. The medicine dispenser further has a carousel with a top platform and a bottom platform. The top platform has a top face with a sealing platform and a side face. A bottom platform of the carousel has grips. Methods of administering a medication from the medicine dispenser and manufacturing the medication dispenser are also described.

### FIELD OF THE DISCLOSURE

The present disclosure generally relates to a medication dispenser for administering medications.

### BACKGROUND OF THE DISCLOSURE

In order to take a medication, a two-step process occurs. First, the medication dispenser must be opened by manually applying force to the medication dispenser. Next, the prescribed medication needs to be removed from the medication dispenser by manually grabbing the prescribed medication. Removing the prescribed medication from the medication dispenser requires fine motor skills, and a full range of motion. However, muscular and neurological disorders, such as Parkinson's Disease, cause bradykinesia, limb rigidity, and tremors.

Bradykinesia slows the body's movements, and not only increases the time to perform physical actions, but also increases the difficulty of initiating bodily movements. Limb rigidity inhibits muscles' ability to stretch and relax. Limb rigidity can lead to the muscles becoming stiff and inflexible, which, in addition to causing pain, increases the difficulty of performing everyday activities, such as dressing, writing, and opening bottles. Tremors are involuntary muscle contractions that cause one or more body parts to twitch. In particular, tremors in the fingers are classified as pill-rolling tremors, which cause the thumb and forefinger to continuously rub back and forth, as if a pill was being rolled between each finger. Pill-rolling tremors not only interfere with everyday tasks, such as dressing, shaving or writing, but also inhibit the ability to perform tasks requiring fine motor skills.

While certain muscular and neurological disorders may be treated with medication, ingesting the required dosage of medication requires the ability to grab and open the medicine dispenser, to retrieve the required amount of medication from the dispenser and to not drop the medication before the medication reaches the oral cavity. Failure at any single stage in this process may increase stress levels and anxiety and exacerbate bradykinesia, limb rigidity and tremors. As these symptoms worsen, medication becomes less responsive as a form of treatment. This causes further impairment and degradation of gross and fine motor skills and the muscular or neurological condition to increase in severity.

As a result, improvements in the field of medication dispensers and administration of medication are needed to ensure those suffering from muscular and neurological disorders can take their prescribed medications and prevent existing symptoms from worsening, promote medication compliance, and augment medication adherence.

### SUMMARY OF THE DISCLOSURE

A medication dispenser is disclosed. The medication dispenser may comprise a main body, wherein the main body may house a medication reservoir between a top end and a bottom end of the main body. The main body may also comprise a delivery tube. One or more steering arms may be located on an external wall of the delivery tube. The medication dispenser may comprise a cap. The medication dispenser may comprise a carousel. The carousel may have a top platform and a bottom platform. The top platform of the carousel may comprise a top face with a sealing platform and may have a side face comprising inserts. The bottom platform of the carousel may comprise grips.

A method of administering a medication is also disclosed. The method may comprise tilting a medication dispenser to move medication to a depression on a top platform of the carousel. The method may comprise turning a bottom platform of a carousel joined to a bottom face of a main body of the medication dispenser in a rotational direction. Turning the bottom platform of the carousel in the rotational direction may move one or more steering arms in the rotational direction. Turning the bottom platform of the carousel may move inserts located on a side face of a top platform of the carousel in the rotational direction. The method may comprise matingly engaging one or more raised inserts of the inserts into an alignment slit. The alignment slit may be located on the bottom face of the main body and may place a sealing platform in a dispense position. The method may comprise guiding a medication dosage to the sealing platform with the one or more steering arms. The sealing platform is located on a top face of the top platform of the carousel. The method may comprise enclosing the sealing platform in a delivery tube. The method may comprise sliding the medication on the sealing platform from a bottom end of the delivery tube to a top end of the delivery tube. The method may comprise guiding the medication dosage from the top end of the delivery tube to an opening that may be located on a cap. The method may comprise passing the medication dosage through the opening, wherein the medication may pass through the opening to exit the medication dispenser.

A method of manufacturing a medication dispenser is also disclosed. The method may comprise injection molding each component of the medicine dispenser, wherein the medicine dispenser may comprise a cap and a main body. The main body may have a top end and bottom end. The medicine dispenser may comprise a delivery tube, one or more steering arms and a carousel. The method of manufacturing may comprise forming a passage into a top face of the cap, forming a depression into a top face of a top platform of the carousel, and forming an alignment slit into the bottom end of the main body. The method of manufacture can comprise demountably sealing the top end of the main body to the top face of the cap, and demountably sealing the bottom end of the main body to the top face of the top platform of the carousel.

These and other objects, features, and advantages of the present disclosure will become more readily apparent from the attached drawings and the detailed description of the preferred embodiments, which follow.

### BRIEF DESCRIPTION OF THE DRAWINGS

FIG. 1 is a perspective view of an exemplary embodiment of the medicine dispenser described in the present disclosure.

FIG. 2 is a body perspective of an exemplary embodiment the main body of the medicine dispenser described in the present disclosure.

FIG. 3 is a side view of an exemplary embodiment the main body of the medicine dispenser described in the present disclosure.

FIG. 4. is a top view of an exemplary embodiment the main body of the medicine dispenser described in the present disclosure.

FIG. 5. is a top perspective view of an exemplary embodiment of the cap of the medicine dispenser described in the present disclosure.

FIG. 6. is a bottom perspective view of an exemplary embodiment of the cap of the medicine dispenser described in the present disclosure.

FIG. 7 is a perspective view of an exemplary embodiment of a carousel of the medicine dispenser described in the present disclosure.

FIG. 8 is another perspective view of an exemplary embodiment the carousel of the medicine dispenser described in the present disclosure.

FIG. 9 is a side view of an exemplary embodiment of the carousel of the medicine dispenser described in the present disclosure.

FIG. 10 is a top view of an exemplary embodiment the carousel of the medicine dispenser described in the present disclosure.

FIG. 11 is a perspective view of an exemplary embodiment the carousel, in another aspect of the present disclosure.

FIG. 12 is another perspective view of an exemplary embodiment the carousel, in another aspect of the present disclosure.

FIG. 13 is a bottom perspective view of an exemplary embodiment the carousel, in another aspect of the present disclosure.

FIG. 14 is another bottom perspective view of an exemplary embodiment the carousel, in another aspect of the present disclosure.

FIG. 15 is a top perspective view of an exemplary embodiment an insert for the carousel, in another aspect of the present disclosure.

FIG. 16 is a bottom perspective view of an exemplary embodiment of the insert for the carousel, in another aspect of the present disclosure.

### DETAILED DESCRIPTION

The invention is defined by the claims. The description is exemplary in nature and should not be used to limit the claims. Other embodiments are contemplated in accordance with the techniques described herein; such embodiments are within the scope of this application. Further, there is no intent to be bound by any expressed or implied theory presented in this application. The words “exemplary” or “illustrative” mean “serving as an example, instance, or illustration.” Any implementations described as “exemplary” or “illustrative” are not to be construed as preferred or advantageous over other implementations. All the implementations described below are exemplary implementations, in order to enable people skilled in the art to make or use the disclosed embodiments and are not intended to limit the scope of the disclosure, which is defined by the claims.

Some features may be described using relative terms, such as “upper,” “lower,” “left,” “rear,” “right,” “front,” “vertical,” and “horizontal.” Such relative terms are only for reference with respect to the appended Figures and are not meant to limit the disclosed embodiments. Hence, specific dimensions and other physical characteristics relating to the disclosed embodiments are not meant to limit the claims, unless expressly stated otherwise in the claims.

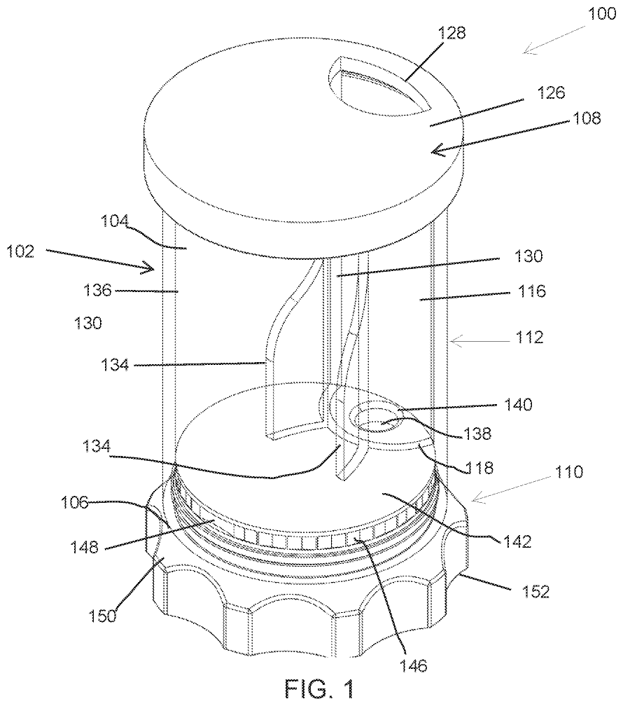

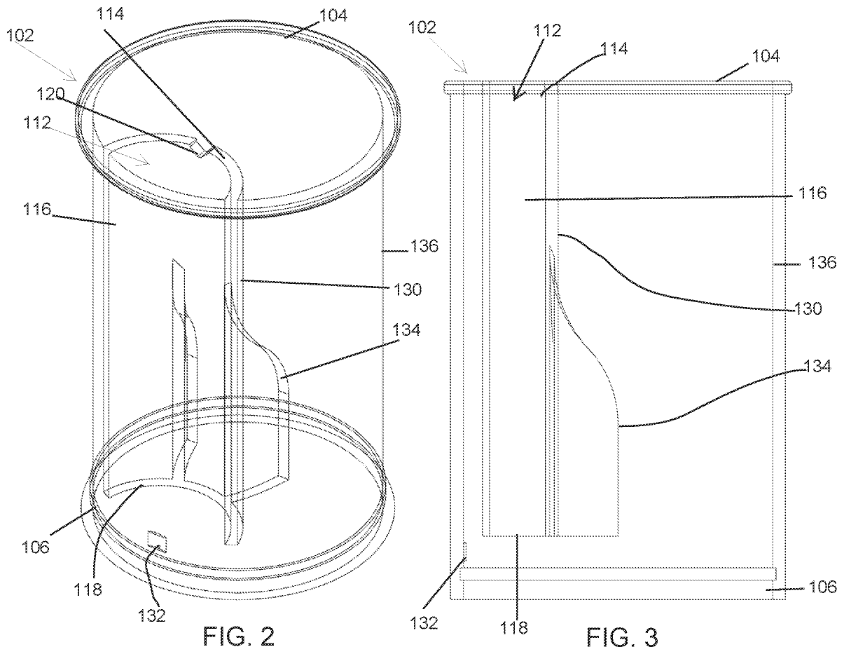

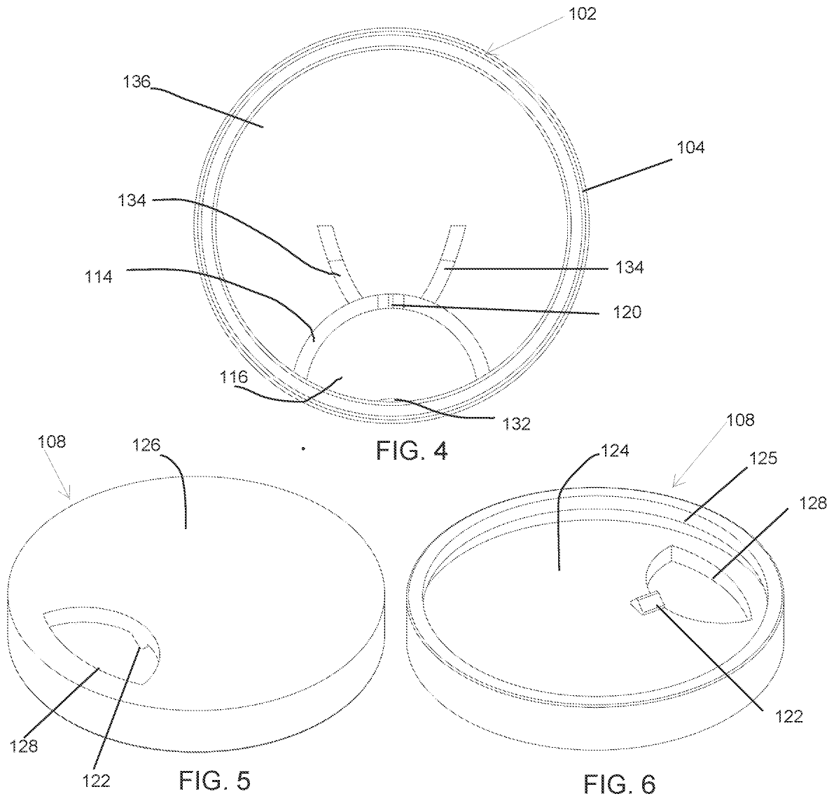

FIG. 1 illustrates a perspective view of a medication dispenser 100. The medication dispenser 100 has a main body 102. The main body 102 may have a top end 104 and a bottom end 106. The top end 104 of the main body 102 may be demountably joined to a cap 108, and the bottom end 106 may be demountably joined to a carousel 110. The main body 102 may also comprise a delivery tube 112, wherein the delivery tube 112 can have a top side 114, as shown below in FIG. 2, a central chamber 116, and a bottom side 118. The top side 114, as shown below in FIG. 2, of the delivery tube 112 may have a notch 120, as shown below in FIG. 2. In some aspects of the present disclosure, the notch 120, as shown below in FIGS. 2 and 4, may matingly engage a tab 122, as shown below in FIGS. 5-6, located on an internal bottom face 124, as shown below in FIG. 6, of the cap 108 and may aid the cap 108 in demountably joining to the top end 104 of the main body 102. In other aspects of the present disclosure, the internal bottom face 124, as shown below in FIG. 6, of the cap 108 may also have a plurality of internal threadings 125, as shown below in FIG. 6, wherein the plurality of internal threadings 125, may demountably secure the top end 104 of the main body 102. The cap 108 may also have an external top face 126, wherein the external top face 126 may have a passage 128 that may be contiguous with the top side 114 of the delivery tube 112, as shown below in FIG. 2. The central chamber 116 of the delivery tube 112 may have an external wall 130. In some aspects of the disclosure, an alignment slit 132, as shown below in FIGS. 2-4, can be located on a portion of the bottom end 106 of the main body 102 that a portion of the external wall 130 of the central chamber 116 of the delivery tube 112 may face in a forward direction, as shown below in FIG. 2. In some aspects of the present disclosure, the alignment slit 132 may be bored into the portion of the bottom end 106 of the main body 102. In other aspects of the present disclosure, the alignment slit 132 may be comprised in a mold, not shown, of the portion of the bottom end 106 of the medication dispenser 100 during injection molding.

One or more steering arms 134 may be attached to the external wall 130 of the delivery tube 112's central chamber 116. The one or more steering arms 134 push one or medications, not shown, that may be stored in a reservoir 136 to a sealing platform 138 within a depression 140 located on a top platform 142 of the carousel 110, wherein the top platform 142 of the carousel 110 may have a side face 144 comprising a plurality of indents 146. One or more of the plurality of indents 146 may comprise one or more raised indents 148 on the side face 144. The alignment slit 132 can contact the plurality of indents 146 and can create a clicking sound when the carousel 110 is spun. The clicking sound can be used to determine the position of the carousel 110. The alignment slit 132 contacting the plurality of indents 146 can also create a tactile sensation that allows a user to determine the position of the carousel 110. Determining the position of the carousel can allow a visually impaired user to understand when the carousel 110 is in the proper position to collect and/or dispense medication.

The one or more steering arms 134 may steer medication in a rotational direction by turning a bottom platform 150 of the carousel 110 in the rotational direction. The steering arms 134 may remain stationery while the medication moves inside the medication dispenser 100 by rotating the carousel 110. The steering arms 134 can steer medication towards to the depression on the top platform 142 of the carousel 110. In some aspects of the present disclosure, the rotational direction is clockwise. In other aspects of the present disclosure, the rotational direction is counterclockwise. The bottom platform 150 of the carousel 110 may have a plurality of grips 152 wherein the plurality of grips 152 allow a user to hold the bottom platform 150 of the carousel 110 and turn the bottom platform 150 of the carousel 110 in the rotational direction. The plurality of indents 146 on the side face 144 of the carousel 110's top platform 142 may also turn in the rotational direction by using the plurality of grips 152 to turn the bottom platform 150 of the carousel 110 in the rotational direction.

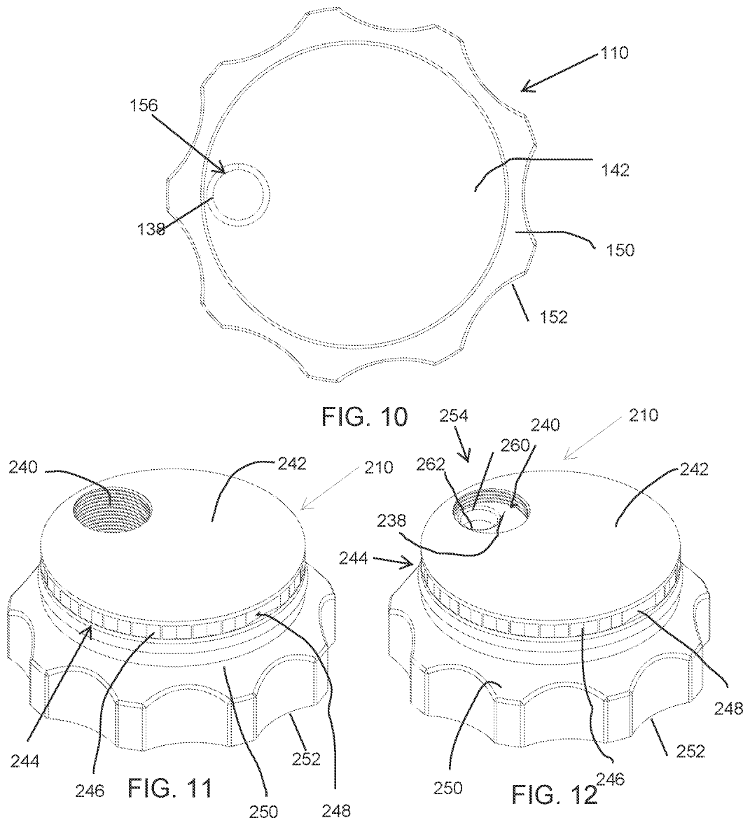

At least one of the raised indents 148 of the plurality of indents 146 may matingly engage the alignment slit 132 located on the portion of the bottom end 106 of the main body 102. At least one of the raised indents 148 of the plurality of indents 146 sets the sealing platform 138 within the depression 140 of the carousel 110's top platform 142 in a dispense position 156, wherein the dispense position 156 enables a medication dosage, not shown, comprising one more medication to treat neurological or muscular disorders, to exit the medication dispenser 100. At least one of the raised indents 148 of the plurality of indents 146 sets the sealing platform 138 within the depression 140 of the carousel 110's top platform 142 in a storage position 158, shown below in FIG. 10, wherein the storage position 158 prevents the medication dosage from exiting the medication dispenser 100. In the dispense position 156, the sealing platform 138 within the depression 140 located on the carousel 110's top platform 142 may receive the medication dosage, not shown, in the dispense position from the one or more steering arms 134.

A user may receive the medication dosage, not shown, when the sealing platform 138 within the depression 140 of the carousel 110's top platform 142 is in the dispense position 156 by tilting the medication dispenser 100 at a downward angle, not shown, wherein the downward angle may have a range between 30°-180°. The bottom side 118 of the delivery tube 112 can be glued to the top platform 142 of the carousel 110, and may prevent the medication dosage, not shown, from escaping the delivery tube 112. Upon tilting the medication dispenser 100 at the downward angle defined above, the medication dosage, not shown, may leave the sealing platform 138 within the depression 140 of the carousel 110's top platform 142 and can slide along the main body 102. The medication dosage, not shown, may then exit the medication dispenser 100 through the passage 128 located on the external top face 126 of the cap 108.

The medication dispenser 100 may be manufactured by injection molding each component of the medication dispenser 100 described above. In some aspects of the present disclosure, the passage 128 found in the external top face 126 of the cap 108 may be bored into the external top face 126 of the cap 108. In other aspects of the present disclosure, the passage 128 found in the external top face 126 of the cap 108 may be found in a mold, not shown, of the medication dispenser 100. The medication dispenser may be made of materials comprising plastic, polyethylene, polypropylene, related synthetic materials, variants thereof, or combinations thereof.

FIG. 2 illustrates a body perspective of the main body 102. The main body 102 may have the top end 104 and the bottom end 106. The main body may have the shape comprising a cylinder, a tube, or variations thereof. The main body may also have the delivery tube 112, wherein the delivery tube 112 can have the top side 114, the central chamber 116, and the bottom side 118. The top side 114 of the delivery tube 112 may be contiguous with the portion of the top end 104 of the main body 102. The top side 114 of the delivery tube 112 may have the notch 120. The notch 120 may matingly engage the tab 122 located on the internal bottom face 124 of the cap 108, shown below in FIGS. 4 and 6 and may aid the cap 108 in demountably joining to the top end 104 of the main body 102, shown above in FIG. 1. The central chamber 116 of the delivery tube 112 may have an external wall 130. In some aspects of the disclosure, the alignment slit 132 can be located on a portion of the bottom end 106 of the main body 102. In some aspects of the present disclosure, may be bored into the portion of the bottom end 106 of the main body 102. In other aspects of the present disclosure, the alignment slit 132 may be comprised in a mold, not shown, of the portion of the bottom end 106 of the medication dispenser 100 during injection molding.

One or more steering arms 134 may be attached to the external wall 130 of the delivery tube 112's central chamber 116. The one or more steering arms 136 push the medication dosage, not shown, stored in the reservoir 136. The bottom side 118 of the delivery tube 112 may be glued to the top platform 142 of the carousel 110 at the bottom end 106 of the main body, shown above in FIG. 1, to prevent the medication dosage, not shown, from escaping the delivery tube 112. Upon tilting the medication dispenser 100 at the first downward angle defined in FIG. 1, the medication dosage, not shown, can slide along the main body 102 and the the central chamber 116 of the delivery tube 112. The medication dosage, not shown, may then exit the medication dispenser by sliding past the top side 114 of the delivery tube 112 and the top end 104 of the main body 102. The main body 102 may be made of materials comprising plastic, polyethylene, polypropylene, related synthetic materials, variants thereof, or combinations thereof.

FIG. 3 illustrates a side view of the main body 102. The main body 102 may have the top end 104 and the bottom end 106. The main body may have a shape comprising a cylinder, a tube, or variations thereof. The main body may also have the delivery tube 112, wherein the delivery tube 112 can have the top side 114, the central chamber 116 and the bottom side 118. The top side 114 of the delivery tube 112 may be contiguous with a portion of the top end 104 of the main body 102. The central chamber 116 of the delivery tube 112 may have an external wall 130. In some aspects of the disclosure, the alignment slit 132 can be located on a portion of the bottom end 106 of the main body 102. In some aspects of the present disclosure, may be bored into the portion of the bottom end 106 of the main body 102. In other aspects of the present disclosure, the alignment slit 132 may be comprised in a mold, not shown, of the portion of the bottom end 106 of the medication dispenser 100 during injection molding. One or more steering arms 133 may be attached to the external wall 130 of the delivery tube 112's central chamber 116. The one or more steering arms 136 push one or medications, not shown, stored in the reservoir 136. The bottom side 118 of the delivery chamber may be glued to the top platform 142 of the carousel 110, shown above in FIG. 1, to prevent the medication dosage, not shown, from escaping the delivery tube 112. Upon tilting the medication dispenser 100 at the first downward angle defined in FIG. 1, the medication dosage, not shown, can slide along the main body 102 and the central chamber 116 of the delivery tube 112. The medication dosage, not shown, may then exit the medication dispenser by sliding past the top side 114 of the delivery tube 112 and the top end 104 of the main body 102. The main body 102 may be made of materials comprising plastic, polyethylene, polypropylene, related synthetic materials, variants thereof, or combinations thereof.

FIG. 4 illustrates a top view of the main body 102. The main body 102 of the medicine dispenser 100 has the top end 104. The top end 104 of the main body 102 may be demountably joined to the cap 108, shown above in FIG. 1. The main body 102 may also comprise a delivery tube 112, wherein the delivery tube 112 can have the top side 114 and the central chamber 116. wherein the top side 114 of the delivery tube 112 may have a notch 120. The notch 120 matingly engages the tab 122 located on the internal bottom face 124 of the cap 108, shown below in FIGS. 5 and 6 and may aid the cap 108 in demountably joining to the top end 104 of the main body 102. The cap 108 may also have an external top face 126, wherein the external top face 126 may have a passage 128 that may be contiguous with the top side 114 of the delivery tube 112. The alignment slit 132 can be located on a portion of the bottom end 106 of the main body 102. In some aspects of the present disclosure, the alignment slit 132 may be bored into the portion of the bottom end 106 of the main body 102. In other aspects of the present disclosure, the alignment slit 132 may be comprised in a mold, not shown, of the portion of the bottom end 106 of the medication dispenser 100 during injection molding. One or more or more steering arms 134 may be attached to the delivery tube 112. The one or more steering arms 134 push the medication dosage, not shown, stored in the reservoir 136. The main body 102 may be made of materials comprising plastic, polyethylene, polypropylene, related synthetic materials, variants thereof, or combinations thereof.

FIG. 5 illustrates a top perspective view of the cap 108. The cap 108 may demountably join the top end 104 of the medicine dispenser, shown above in FIG. 1. The cap 108 may have the external top face 126. A passage 128 encompassing a portion of the external top face 126 of the cap 108 is contiguous with the tab 122 on the internal bottom face 124 of the cap 108, shown below in FIG. 6, of the cap 108. The tab 122 on the internal bottom face 124 of the cap 108 may matingly engage the notch 120 located on the top side 114 of the delivery tube 112, shown above in FIGS. 2 and 4. The medication dosage, not shown, may be released from the medication dispenser 100 by traveling through the passage 128 encompassing the portion of the external top face 126 of the cap 108. The cap 108 may be made of materials comprising plastic, polyethylene, polypropylene, related synthetic materials, variants thereof, or combinations thereof.

FIG. 6 illustrates a bottom perspective view of the cap 108. The cap 108 may demountably join the top end 104 of the medicine dispenser, shown above in FIG. 1. In some aspects of the present disclosure, the tab 122 located on the internal bottom face 124 of the cap 108 may matingly engage the notch 120, shown above in FIGS. 2 and 4, in order demountably join the cap 108 to the top end 104 of the main body 102, shown above in FIG. 1. In other aspects of the present disclosure, the internal bottom face 124 of the cap 108 may also have the plurality of internal threadings 125, wherein the plurality of internal threadings 125, may demountably secure the cap 108 to the top end 104 of the main body 102, shown above in FIG. 1. The passage 128 encompassing the portion of the internal bottom face 124 of the cap 108 can be contiguous with the tab 122 on the internal bottom face 124 of the cap 108. The medication dosage, not shown, may be released from the medication dispenser 100, shown above in FIG. 1, by traveling through the passage 128 encompassing the portion of the internal bottom face 124 of the cap 108. The cap 108 may be made of materials comprising plastic, polyethylene, polypropylene, related synthetic materials, variants thereof, or combinations thereof.

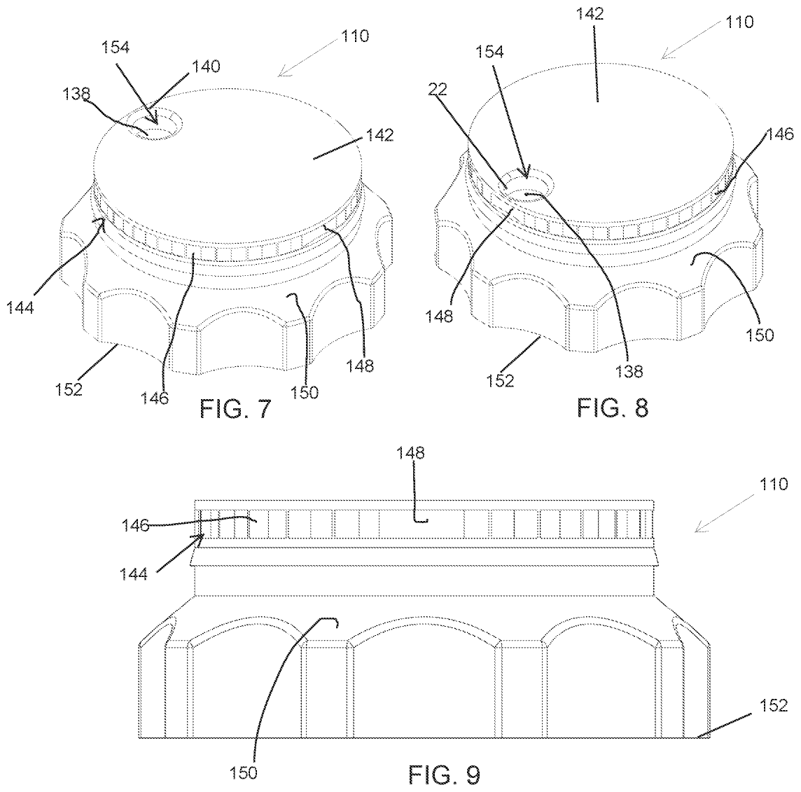

FIG. 7 illustrates a perspective view of the carousel 110. The sealing platform 138 may receive a medication dosage, not shown. The top platform may have a side face 144 comprising a plurality of indents 146. One or more of the plurality of indents 146 may comprise one or more raised indents 148 on the side face 144. The alignment slit 132 can contact the plurality of indents 146 and can create a clicking sound when the carousel 110 is spun. The clicking sound can be used to determine the position of the carousel 110. The alignment slit 132 contacting the plurality of indents 146 can also create a tactile sensation that allows a user to determine the position of the carousel 110. Determining the position of the carousel can allow a visually impaired user to understand when the carousel 110 is in the proper position to collect and/or dispense medication.

The carousel 110 may have the bottom platform 150, wherein the bottom platform 150 may have grips 152. The grips 152 on the bottom platform 150 of the carousel 110 may allow a user to hold the bottom platform 150 of the carousel 110 and turn the bottom platform 150 of the carousel 110 in the rotational direction described above in FIG. 1. The plurality of indents 146 on the side face 144 of the carousel 110's top platform 142 may also turn in the rotational direction described above in FIG. 1 by using the plurality of grips 152 to turn the bottom platform 150 of the carousel 110 in the rotational direction. At least one of the raised indents 148 of the plurality of indents 146 may matingly engage the alignment slit 132, shown above in FIGS. 2-4, located on the portion of the bottom end 106 of the main body 102, shown above in FIGS. 1-3. At least one of the raised indents 148 of the plurality of indents 146 sets the sealing platform 138 within the depression 140 of the carousel 110's top platform 142 in the dispense position 154. The dispense position 154 causes a medication dosage, not shown, to exit the medication dispenser 100, shown above in FIG. 1. The carousel 110 may be made of materials comprising plastic, polyethylene, polypropylene, related synthetic materials, variants thereof, or combinations thereof.

FIG. 8 illustrates another perspective view of the carousel 110. The carousel 110 may have a top platform 142, wherein the top platform 142 may have a sealing platform 138 within a depression 140 located on the carousel 110's top platform 142. The sealing platform 138 may receive a medication dosage, not shown. The top platform may have a side face 144 comprising a plurality of indents 146. One or more of the plurality of indents 146 may comprise one or more raised indents 148 on the side face 144. The carousel 110 may have the bottom platform 150, wherein the bottom platform 150 may have grips 152. The grips 152 on the bottom platform 150 of the carousel 110 may allow a user to hold the bottom platform 150 of the carousel 110 and turn the bottom platform 150 of the carousel 110 in the rotational direction described above in FIG. 1. The plurality of indents 146 on the side face 144 of the carousel 110's top platform 142 may also turn in the rotational direction described above in FIG. 1 by using the plurality of grips 152 to turn the bottom platform 150 of the carousel 110 in the rotational direction. At least one of the raised indents 148 of the plurality of indents 146 may matingly engage the alignment slit 132, shown above in FIGS. 2-4, located on the portion of the bottom end 106 of the main body 102, shown above in FIGS. 1-3. At least one of the raised indents 148 of the plurality of indents 146 sets the sealing platform 138 within the depression 140 of the carousel 110's top platform 142 in the dispense position 154. The dispense position 154 causes a medication dosage, not shown, to exit the medication dispenser 100, shown above in FIG. 1. The carousel 110 may be made of materials comprising plastic, polyethylene, polypropylene, related synthetic materials, variants thereof, or combinations thereof.

FIG. 9 illustrates a side view of the carousel 110. The carousel 110 may have a top platform 142, shown above in FIGS. 7-8, wherein the top platform 142 may have the sealing platform 138 within the depression 140 located on the top platform 142. The top platform 142 may also have the side face 144 comprising the plurality of indents 146. One or more of the plurality of indents 146 may comprise one or more raised indents 148 on the side face 144. The carousel 110 may have the bottom platform 150, wherein the bottom platform 150 may have grips 152. The grips 152 on the bottom platform 150 of the carousel 110 may allow a user to hold the bottom platform 150 of the carousel 110 and turn the bottom platform 150 of the carousel 110 in the rotational direction described above in FIG. 1. The plurality of indents 146 on the side face 144 of the carousel 110's top platform 142 may also turn in the rotational direction described above in FIG. 1 by using the plurality of grips 152 to turn the bottom platform 150 of the carousel 110 in the rotational direction. At least one of the raised indents 148 of the plurality of indents 146 may matingly engage the alignment slit 132, shown above in FIGS. 2-4, located on the portion of the bottom end 106 of the main body 102. The carousel 110 may be made of materials comprising plastic, polyethylene, polypropylene, related synthetic materials, variants thereof, or combinations thereof.

FIG. 10 illustrates a top view of the carousel 110. The carousel 110 may be demountably joined to the bottom end 106 of the main body, shown above in FIG. 1. The carousel 110 may have the top platform 142, wherein the top platform 142 may have a sealing platform 138. The carousel 110 may have the bottom platform 150, wherein the bottom platform 150 may have grips 152. The grips 152 on the bottom platform 150 of the carousel 110 may allow a user to hold the bottom platform 150 of the carousel 110 and turn the bottom platform 150 of the carousel 110 in the rotational direction described above in FIG. 1. The sealing platform 138 may be set in the storage position 156, wherein the storage position prevents the medication dosage, not shown, from exiting the medication dispenser 100, shown above in FIG. 1. The carousel 110 may be made of materials comprising plastic, polyethylene, polypropylene, related synthetic materials, variants thereof, or combinations thereof.

FIG. 11 illustrates a perspective view of the carousel 210, in another aspect of the present disclosure. The carousel 210 may have a top platform 242, wherein a ribbed depression 240 may receive a sealing platform 238, shown below in FIG. 12. The top platform 242 of the carousel 210 may also have a side face 244 comprising a plurality of indents 246. One or more of the plurality of indents 246 may comprise one or more raised indents 248 on the side face 244. The bottom platform 250 of the carousel 210 may have a plurality of grips 252 wherein the plurality of grips 252 may allow a user to hold the bottom platform 250 of the carousel 210 and to turn the bottom platform 250 of the carousel 210 in the rotational direction described above in FIG. 1. At least one of the raised indents 248 of the plurality of indents 246 may matingly engage an alignment slit 232, not shown, wherein the alignment slit 232 can be located on a portion of the bottom end 206 of the main body 202, not shown. The carousel 210 may be made of materials comprising plastic, polyethylene, polypropylene, related synthetic materials, variants thereof, or combinations thereof.

FIG. 12 illustrates a perspective view of the carousel 210 in another aspect of the present disclosure. The carousel 210 may have a top platform 242, wherein a ribbed depression 240 may receive a sealing platform 238 with a chamber 260 encompassing a portion of an external top face 258 of the sealing platform 238 and an innermost platform 262 within the sealing platform 238. The innermost platform 262 may store a medication dosage that may be released from the medication dispenser 200, not shown, in the dispense position 254. The top platform 242 of the carousel 210 may also have a side face 244 comprising a plurality of indents 246. One or more of the plurality of indents 246 may comprise one or more raised indents 248 on the side face 244. The bottom platform 250 of the carousel 210 may have a plurality of grips 252 wherein the plurality of grips 252 can allow a user to hold the bottom platform 250 of the carousel 210 and to turn the bottom platform 250 of the carousel 210 in the rotational direction described above in FIG. 1. At least one of the raised indents 248 of the plurality of indents 246 may matingly engage an alignment slit 232, not shown, wherein the alignment slit 232 can be located on a portion of the bottom end 206 of the main body 202, not shown. At least one of the raised indents 248 of the plurality of indents 246 may set the sealing platform 238, within the threaded depression 240 of the carousel 210's top platform 242 in the dispense position 254. The carousel 210 may be made of materials comprising plastic, polyethylene, polypropylene, related synthetic materials, variants thereof, or combinations thereof.

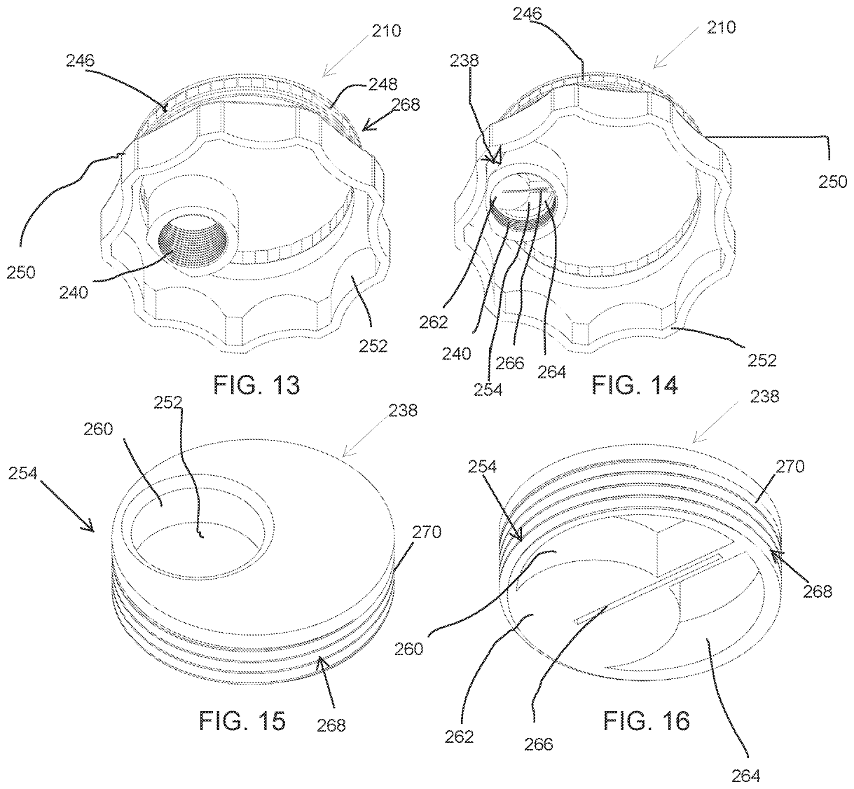

FIG. 13 illustrates a bottom perspective view of the carousel 210, in another aspect of the present disclosure. The carousel 210 may have the ribbed depression 240 in the top platform 242 of the carousel 210, shown above in FIG. 11, wherein the ribbed depression 240 may receive a sealing platform 238, shown below in FIG. 14. The top platform 242, shown above in FIG. 11, of the carousel 210 may also have a side face 244 comprising a plurality of indents 246. One or more of the plurality of indents 246 may comprise one or more raised indents 248 on the side face 244. The bottom platform 250 of the carousel 210 may have a plurality of grips 252 wherein the plurality of grips 252 can allow a user to hold the bottom platform 250 of the carousel 210 and to turn the bottom platform 250 of the carousel 210 in the rotational direction described above in FIG. 1. At least two of the raised indents 248 of the plurality of indents 246 may matingly engage an alignment slit 232, not shown, wherein the alignment slit 232 can be located on a portion of the bottom end 206 of the main body 202, not shown. The carousel 210 may be made of materials comprising plastic, polyethylene, polypropylene, related synthetic materials, variants thereof, or combinations thereof.

FIG. 14 illustrates a bottom perspective view of the carousel 210, in another aspect of the present disclosure. The carousel 210 may have a top platform 242, shown above in FIG. 12, wherein the ribbed depression 240 may receive a sealing platform 238 with an internal bottom face 264 and the innermost platform 262. The innermost platform 262 within the sealing platform 238 may store the medication dosage that may be released from the medication dispenser 200, not shown, in the dispense position 254, shown above in FIG. 12. The internal bottom face 264 of the sealing platform may also have the slot 266. In some aspects of the present disclosure, the slot 266 of the internal bottom face 264 of the sealing platform 238 may receive screws, fasteners, variants thereof, or combinations thereof, to fasten the sealing platform 238 to the threaded depression 240 located on the top platform 242 of the carousel 210. In other aspects of the present disclosure, the threaded ridges 270 on the side face 268 of the sealing platform 238 may engage with the threaded depression 240 to secure the sealing platform 238 to the threaded depression 240 located on the top platform 242 of the carousel 210.

The top platform 242, shown above in FIG. 11, of the carousel 210 may also have a side face 244 comprising a plurality of indents 246. One or more of the plurality of indents 246 may comprise one or more raised indents 248 on the side face 244. The bottom platform 250 of the carousel 210 may have the plurality of grips 252 wherein the plurality of grips 252 can allow the user to hold the bottom platform 250 of the carousel 210 and to turn the bottom platform 250 of the carousel 210 in the rotational direction described above in FIG. 1. At least two of the raised indents 248 of the plurality of indents 246 may matingly engage the alignment slit 232, not shown, wherein the alignment slit 232 can be located on the portion of the bottom end 206 of the main body 202, not shown. At least one of the raised indents 248 of the plurality of indents 246 may set the sealing platform 238 within the threaded depression 240 of the carousel 210's top platform 242 in the dispense position 254, shown above in FIG. 12. The carousel 210 may be made of materials comprising plastic, polyethylene, polypropylene, related synthetic materials, variants thereof, or combinations thereof.

FIG. 15 illustrates a top perspective view of the sealing platform 238, in another aspect of the present disclosure. The sealing platform 238 may comprise the chamber 260 in the portion of the external top face 258 of the sealing platform 238, wherein the chamber 260 may have the innermost platform 262. The innermost platform 262 may store a medication dosage that may be released from the medication dispenser 200, not shown, in the dispense position 254. The sealing platform may also comprise a side face 268, wherein the side may have threaded ridges 270. The threaded ridges 270 of the side face 268 may engage with the threaded depression 240 to secure the sealing platform 238 to the threaded depression 240 located on the top platform 242 of the carousel 210. The sealing platform 238 may be made of materials comprising plastic, polyethylene, polypropylene, related synthetic materials, variants thereof, or combinations thereof.

FIG. 16 illustrates a bottom perspective view of the sealing platform 238, in another aspect of the disclosure. The sealing platform 238 may comprise the chamber 260 in the portion of the internal bottom face 264 of the sealing platform 238, wherein the chamber 260 may have the innermost platform 262. The innermost platform 262 may store a medication dosage that may be released from the medication dispenser 200, not shown, in the dispense position 254. The internal bottom face 264 of the sealing platform may also have the slot 266. In some aspects of the present disclosure, the slot 266 of the internal bottom face 264 of the sealing platform 238 may receive screws, fasteners, variants thereof, or combinations thereof, to fasten the sealing platform 238 to the threaded depression 240 located on the top platform 242 of the carousel 210. In other aspects of the present disclosure, the threaded ridges 270 on the side face 268 of the sealing platform 238 may engage with the threaded depression 240 to secure the sealing platform 238 to the threaded depression 240 located on the top platform 242 of the carousel 210. The sealing platform 238 may be made of materials comprising plastic, polyethylene, polypropylene, related synthetic materials, variants thereof, or combinations thereof.

Since many modifications, variations, and changes in detail can be made to the described preferred embodiments of the invention, it is intended that all matters in the foregoing description and shown in the accompanying drawings be interpreted as illustrative and not in a limiting sense.

Although some, and maybe preferred, embodiments of the disclosure have been described in detail herein, those skilled in the art will recognize that various substitutions and modifications may be made without departing from the scope and spirit of the appended claims. Thus, the scope of the invention should be determined by the appended claims and their legal equivalents.

I claim:

1. A medication dispenser, comprising:
a main body, wherein the main body houses a medication reservoir between a top end and a bottom end of the main body, and a delivery tube, further wherein one or more steering arms are located on an external wall of the delivery tube;
a cap;
a carousel, wherein the carousel has a top platform and a bottom platform, wherein the top platform has a top face with a sealing platform and a side face; and
further wherein the bottom platform of the carousel has grips.

2. The medicine dispenser of claim 1, wherein the side face comprises raised indents and the sealing platform located on the top face of the top platform of the carousel has a dispense position and a storage position.

3. The medicine dispenser of claim 2, wherein the sealing platform located on the top face of the top platform of the carousel is located in a depression in the dispense position.

4. The medication dispenser of claim 1, wherein one or more of the of inserts has raised inserts.

5. The medication dispenser of claim 1, wherein the delivery tube has a top side, a central cavity, and a bottom side.

6. The medication dispenser of claim 5, wherein the top side of the delivery tube has a notch.

7. The medication dispenser of claim 1, wherein the cap has a top face and a bottom face.

8. The medication dispenser of claim 1, wherein the top face of the cap has a passage located on a portion of the top face of the cap.

9. The medicine dispenser of claim 1, wherein the bottom face of the cap has a tab.

10. The medicine dispenser of claim 1, wherein the bottom end of the main body has an alignment slit.

11. A method of administering a medication dosage, the method comprising:
tilting a medication dispenser at a downward angle to move medication into a depression on a top platform of a carousel;
turning a bottom platform of a carousel joined to a bottom face of a main body of the medication dispenser in a rotational direction, wherein turning the bottom platform of the carousel in the rotational direction moves one or more steering arms in the rotational direction;
matingly engaging one or more raised inserts of the plurality of inserts into an alignment slit, wherein the alignment slit is located on the bottom face of the main body and places a sealing platform in a dispense position;
guiding a medication dosage to the sealing platform located on a top face of the top platform of the carousel with the one or more steering arms;
enclosing the sealing platform in a delivery tube;
sliding the medication dosage on the sealing platform from a bottom end of the delivery tube to a top end of the delivery tube;
guiding the medication dosage from the top end of the delivery tube to an opening located on a cap; and
passing the medication dosage through the opening located on the cap, wherein the medication dosage passes through the opening to exit the medication dispenser.

12. The method of claim 11, wherein turning the bottom platform of the carousel occurs by turning ridges on the bottom platform of the carousel.

13. The method of claim 11, wherein the rotational direction for the bottom face of the carousel is clockwise.

14. The method of claim 11, wherein the rotational direction for the bottom face of the carousel is counterclockwise.

15. The method of claim 11, wherein the downward angle has a range between 30°-180°.

16. The method of claim 11, further comprises placing the sealing platform in the dispense position by depressing the sealing platform into an opening located on the top face of the top platform of the carousel.

17. A method of manufacturing a medicine dispenser, the method comprising:
injection molding each component of the medicine dispenser, wherein the medicine dispenser comprises a cap, a main body, wherein the main body has a top end and bottom end, one or more steering arms, a delivery tube and a carousel;
forming a passage into a top face of the cap;
forming a depression into a top face of a top platform of the carousel;
forming at least one alignment slit into the bottom end of the main body; and
demountably sealing the top end of the main body to the top face of the cap and the bottom end of the main body to the top face of the top platform of the carousel.

18. The method of claim 17, wherein a plurality of grips is molded into a bottom face of the carousel.

19. The method of claim 17, wherein a bottom face of the cap has a tab that demountably joins a notch etched into a top end of the delivery tube.

20. The method of claim 17, wherein the top end of the delivery tube is contiguous with the top end of the main body.
